(19) United States
(12) Patent Application Publication
(10) Pub. No.: US 2026/0084221 A1
(43) Pub. Date: Mar. 26, 2026

(54) CUTTING INSERT, CUTTING TOOL, AND METHOD FOR MANUFACTURING MACHINED PRODUCT

(71) Applicant: KYOCERA CORPORATION, Kyoto (JP)

(72) Inventors: Shin NAGAE, Kyoto (JP); Hirotoshi GONZUI, Kyoto (JP)

(21) Appl. No.: 19/107,024

(22) PCT Filed: Aug. 14, 2023
(86) PCT No.: PCT/JP2023/029398

§ 371 Date: Feb. 27, 2025

(30) Foreign Application Priority Data
Aug. 31, 2022 (JP) 2022-137685

(51) Int. Cl. B23B 27/16; B23B 1/00

(52) U.S. Cl. CPC B23B 27/1611; B23B 1/00

(57) ABSTRACT

The present disclosure achieves both an improvement in the surface accuracy of a machined surface of a workpiece, and an improvement in the durability of a cutting insert. A main rake surface has a linear shape that approaches a reference plane with increasing distance from a land surface in a cross section orthogonal to an outer edge of an upper surface. The land surface includes a first land surface located along the corner portion, and a second land surface located along the side portion. The first land surface includes a first linear portion having a linear shape in a cross section orthogonal to the corner portion, and the second land surface has a protrusively curved shape as a whole in a cross section orthogonal to the side portion.

### TECHNICAL FIELD

The present disclosure relates to a cutting insert used in machining of a workpiece, a cutting tool, and a method for manufacturing a machined product.

### BACKGROUND OF INVENTION

As a cutting insert used in a case of machining a workpiece made of a metal or the like, cutting inserts disclosed in Patent Documents 1 and 2 have been known, for example. Each of the cutting inserts described in Patent Documents 1 and 2 includes a land surface (referred to as a first rake surface in Patent Document 1, and referred to as a land in Patent Document 2) located along an outer edge of an upper surface thereof, and a rake surface located along the land surface. In a case that the cutting insert is provided with the land surface, the cutting edge strength of a cutting edge is enhanced and the durability of the cutting insert is improved. Therefore, for example, in a case that performing machining in which a large cutting load is applied to the cutting edge, such as semi-roughing, the cutting insert including the land surface is proactively used. In the cutting inserts described in Patent Documents 1 and 2, the shape of the land surface in a cross section orthogonal to the outer edge of the upper surface thereof (hereinafter, referred to as a cross-sectional shape of the land surface as appropriate) is a linear shape, but the cross-sectional shape of the land surface may be a protrusively curved shape.

### CITATION LIST

### Patent Literature

Patent Document 1: WO 2011/037186.

Patent Document 2: WO 2015/141428.

### SUMMARY

A cutting insert according to the present disclosure includes an upper surface, a lower surface located on an opposite side to the upper surface, a lateral surface located between the upper surface and the lower surface, and a cutting edge located at an intersection of the upper surface and the lateral surface. A virtual axis that passes through the center of the upper surface and the center of the lower surface is taken as an insert central axis, and a virtual flat surface located between the upper surface and the lower surface and orthogonal to the insert central axis is taken as a reference plane. The upper surface includes an outer edge comprising a corner portion having a protrusively curved shape and a side portion having a linear shape and extending from the corner portion, a land surface located along the outer edge, and a rake surface located along the land surface and having a linear shape, in a cross section orthogonal to the outer edge, that approaches the reference plane with increasing distance from the land surface. The land surface includes a first land surface located along the corner portion, and a second land surface located along the side portion. The first land surface includes a first linear portion having a linear shape in a cross section orthogonal to the corner portion. The second land surface has a protrusively curved shape as a whole in a cross section orthogonal to the side portion.

A cutting tool according to the present disclosure includes a holder and the cutting insert according to the present disclosure. The holder has a rod shape extending from a first end to a second end, and includes a pocket located on a side of the first end. The cutting insert is located in the pocket.

### BRIEF DESCRIPTION OF THE DRAWINGS

FIG. 1 is a schematic perspective view of a cutting insert according to an embodiment of the present disclosure.

FIG. 2 is a schematic top view of the cutting insert illustrated in FIG. 1.

FIG. 3 is an enlarged view of a portion III in FIG. 2.

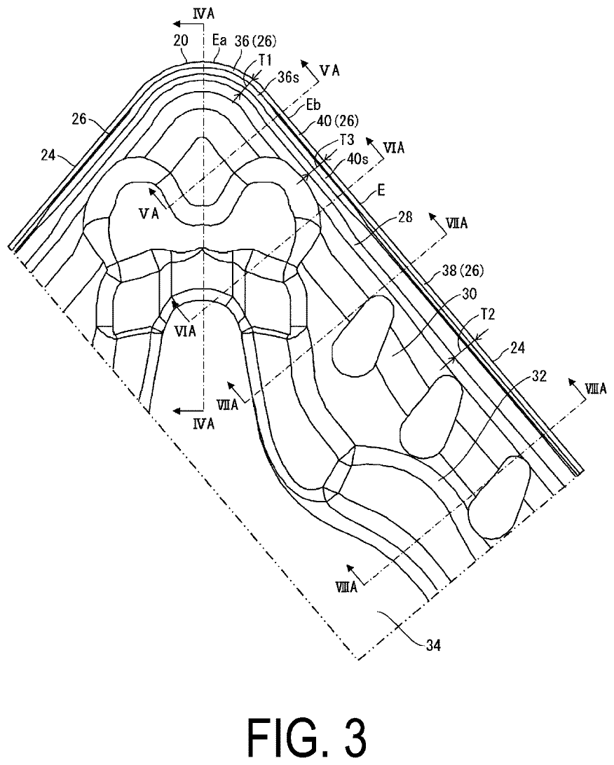

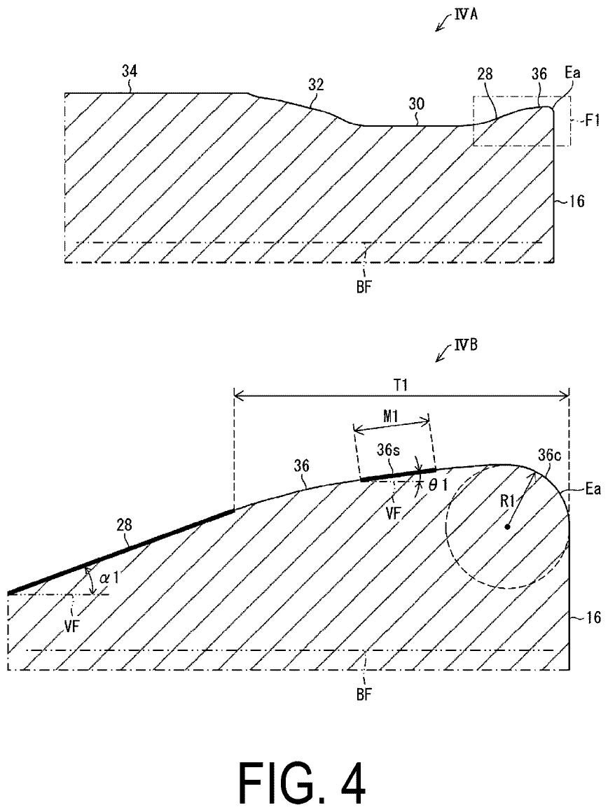

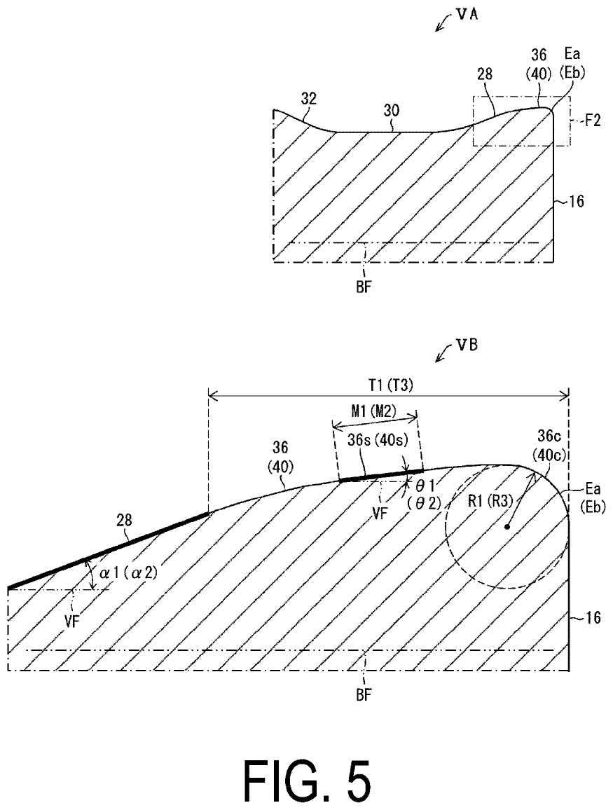

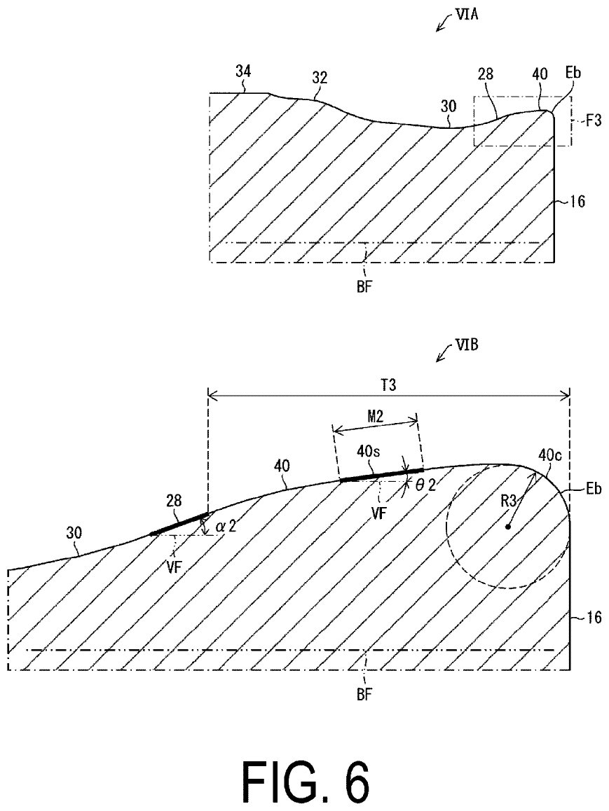

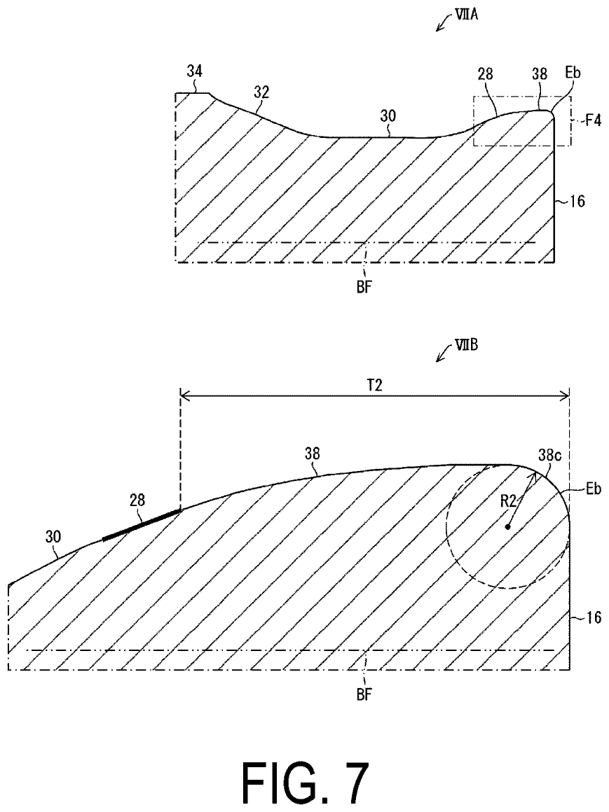

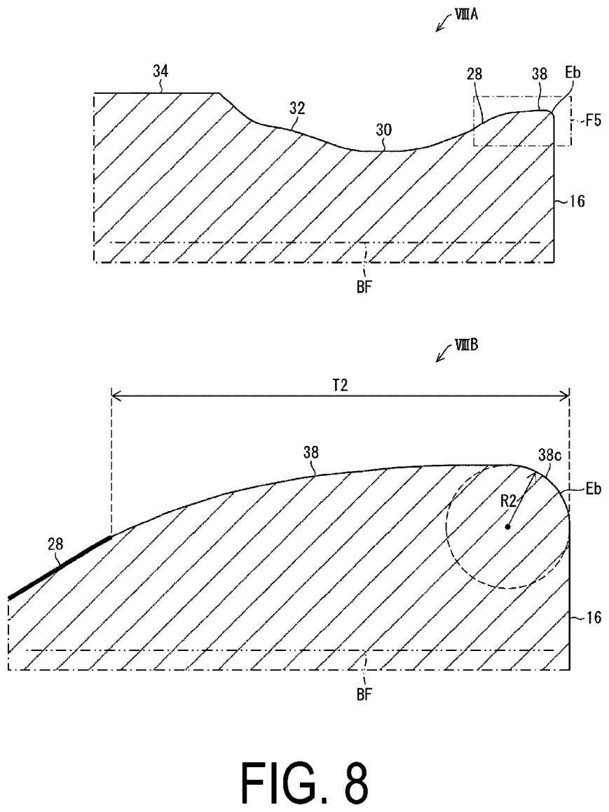

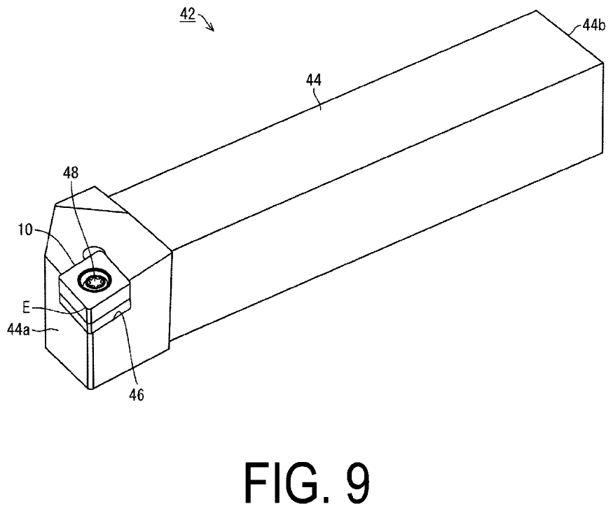

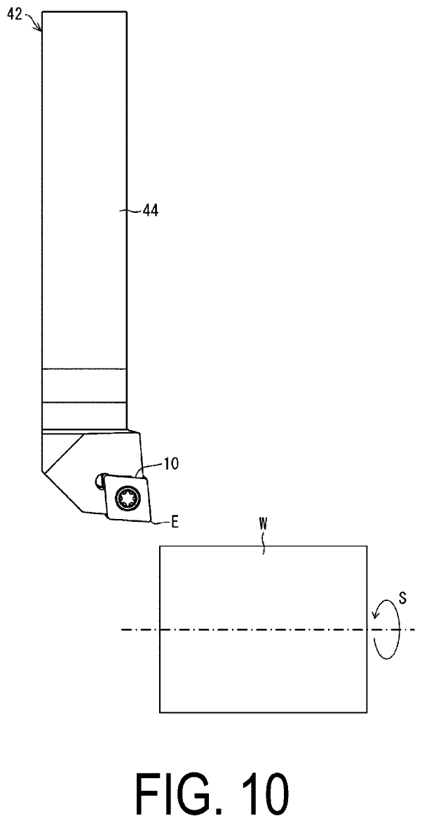

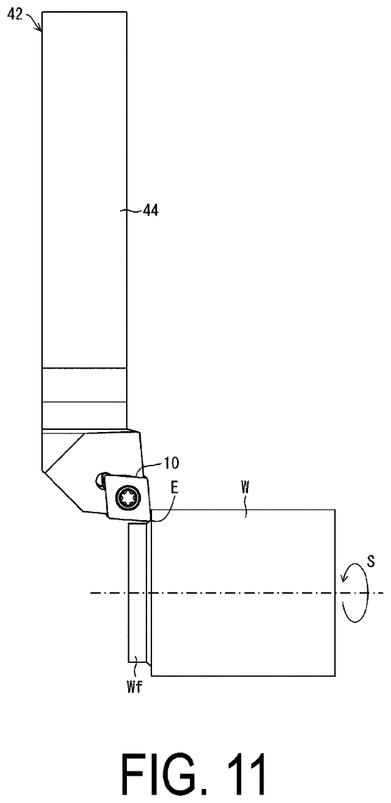

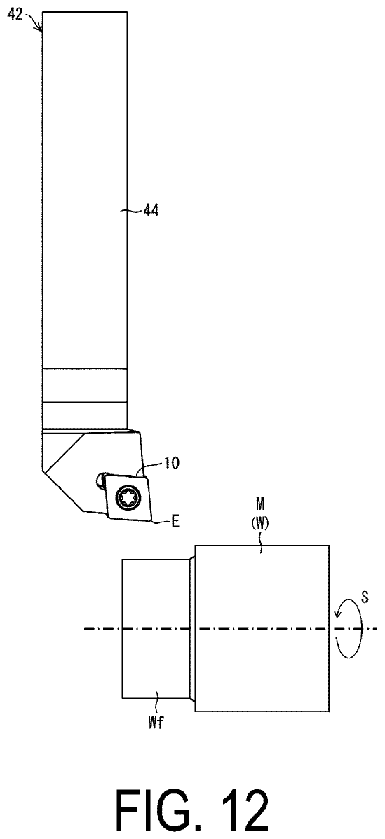

IVA in FIG. 4 is a schematic cross-sectional view taken along a line IVA-IVA in FIG. 3. IVB in FIG. 4 is an enlarged view of a portion F1 of IVA in FIG. 4.

VA in FIG. 5 is a schematic cross-sectional view taken along a line VA-VA in FIG. 3. VB in FIG. 5 is an enlarged view of a portion F2 of VA in FIG. 5.

VIA in FIG. 6 is a schematic cross-sectional view taken along a line VIA-VIA in FIG. 3. VIB in FIG. 6 is an enlarged view of a portion F3 of VIA in FIG. 6.

VIIA in FIG. 7 is a schematic cross-sectional view taken along a line VIIA-VIIA in FIG. 3.

VIIB in FIG. 7 is an enlarged view of a portion F4 of VIIA in FIG. 7.

VIIIA in FIG. 8 is a schematic cross-sectional view taken along a line VIIIA-VIIIA in FIG. 3.

VIIIB in FIG. 8 is an enlarged view of a portion F5 of VIIIA in FIG. 8.

FIG. 9 is a schematic perspective view of a cutting tool according to the embodiment of the present disclosure.

FIG. 10 is a schematic view illustrating a method for manufacturing a machined product according to the embodiment of the present disclosure.

FIG. 11 is a schematic view illustrating the method for manufacturing the machined product according to the embodiment of the present disclosure.

FIG. 12 is a schematic view illustrating the method for manufacturing the machined product according to the embodiment of the present disclosure.

### DESCRIPTION OF EMBODIMENTS

In a case that a cross-sectional shape of a land surface is a linear shape, a cutting edge is sharpened to enhance the sharpness of the cutting edge and improve the surface accuracy of a machined surface of a workpiece. However, edge chipping or the like is likely to occur in the cutting edge, and there is concern about a deterioration in the durability of a cutting insert, in a case that the cross-sectional shape of the land surface is a protrusively curved shape, edge chipping or the like is less likely to occur in the cutting edge, and the durability of the cutting insert is improved. However, the sharpness of the cutting edge is less likely to be enhanced, and there is concern about a deterioration in the surface accuracy of the machined surface of the workpiece. In recent years, there has been a demand to achieve both an improvement in the surface accuracy of the machined surface of the workpiece and an improvement in the durability of the cutting insert.

According to the present disclosure, both the improvement in the surface accuracy of the machined surface of the workpiece and the improvement in the durability of a cutting insert can be achieved.

A cutting insert, a cutting tool, and a method for manufacturing a machined product according to an embodiment of the present disclosure will be described below in detail with reference to the drawings. However, each of the drawings, which will be referred to below, is a simplified representation of only components necessary for description of the embodiment, for convenience of description. Accordingly, the cutting insert and the cutting tool according to an embodiment of the present disclosure may be provided with an optional component that is not illustrated in each of the referred drawings. The dimensions of the components in the drawings do not faithfully represent the actual dimensions of the components, the dimension ratios of the members, or the like.

In the present disclosure, the term “orthogonal” is not limited to being strictly orthogonal and means that an error of approximately ±5 degrees is allowed. The term “parallel” is not limited to being strictly parallel and means that an error of about ±5 degrees is allowed.

### Cutting Insert

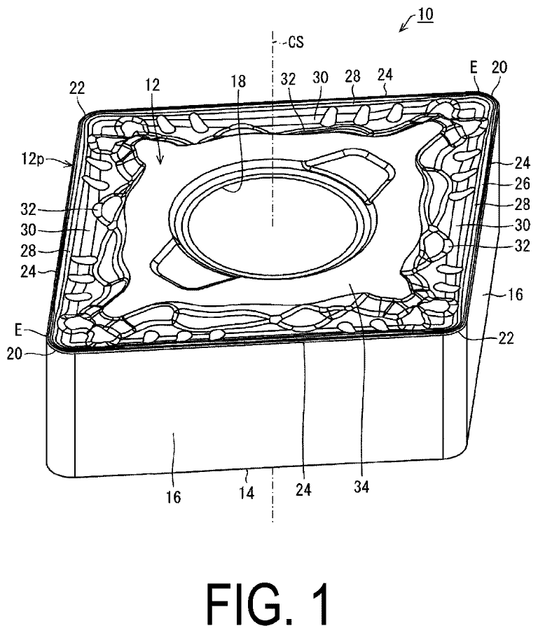

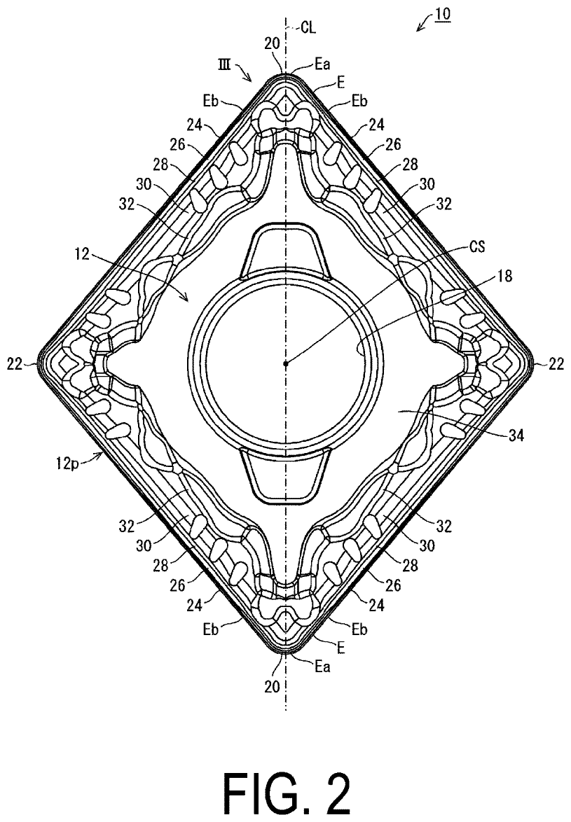

A cutting insert 10 according to the embodiment of the present disclosure will be described with reference to FIGS. 1 to 8. FIG. 1 is a schematic perspective view of the cutting insert 10 according to the embodiment of the present disclosure. FIG. 2 is a schematic top view of the cutting insert 10 illustrated in FIG. 1. FIG. 3 is an enlarged view of a portion III in FIG. 2. IVA in FIG. 4 is a schematic cross-sectional view taken along a line IVA-IVA in FIG. 3. IVB in FIG. 4 is an enlarged view of a portion F1 of IVA in FIG. 4. VA in FIG. 5 is a schematic cross-sectional view taken along a line VA-VA in FIG. 3. VB in FIG. 5 is an enlarged view of a portion F2 of VA in FIG. 5. VIA in FIG. 6 is a schematic cross-sectional view taken along a line VIA-VIA in FIG. 3. VIB in FIG. 6 is an enlarged view of a portion F3 of VIA in FIG. 6. VIIA in FIG. 7 is a schematic cross-sectional view taken along a line VIIA-VIIA in FIG. 3. VIIB in FIG. 7 is an enlarged view of a portion F4 of VIIA in FIG. 7. VIIIA in FIG. 8 is a schematic cross-sectional view taken along a line VIIIA-VIIIA in FIG. 3. VIIIB in FIG. 8 is an enlarged view of a portion F5 of VIIIA in FIG. 8.

As in the example illustrated in FIGS. 1 and 2, the cutting insert 10 may be a replaceable insert used for machining a workpiece W (see FIG. 10). The cutting insert 10 may include an upper surface 12 and a lower surface 14 located on the opposite side of the upper surface 12. Each of the upper surface 12 and the lower surface 14 may have a quadrilateral shape. The cutting insert 10 may have a quadrilateral plate shape. Each of the upper surface 12 and the lower surface 14 may have a polygonal shape other than a quadrilateral shape, for example, a triangular shape or a pentagonal shape. The cutting insert 10 may have a polygonal plate shape other than a quadrilateral plate shape, for example, a triangular plate shape or a quadrilateral plate shape. The polygonal shape is not limited strictly to a shape of a polygon.

As in the example illustrated in FIGS. 1 and 2, each of the upper surface 12 and the lower surface 14 may have a rotationally symmetrical shape at constant angles with respect to an insert central axis CS. In other words, the cutting insert 10 may have a rotationally symmetrical shape at a constant angle with respect to the insert central axis CS. The insert central axis CS refers to a virtual axis passing through the center of the upper surface 12 and the center of the lower surface 14.

The cutting insert 10 may include a plurality of lateral surfaces 16 located between the upper surface 12 and the lower surface 14. Each of the plurality of lateral surfaces 16 may be connected to the upper surface 12 and the lower surface 14. The lateral surface 16 may function as a flank face.

The cutting insert 10 may include an attachment hole 18 penetrating from the upper surface 12 to the lower surface 14. One opening portion of the attachment hole 18 may be located in a center portion of the upper surface 12, and the other opening portion of the attachment hole 18 may be located in a center portion of the lower surface 14. The central axis of the attachment hole 18 may coincide with the insert central axis CS.

The cutting insert 10 may include a cutting edge E located at the intersection of the upper surface 12 and the lateral surface 16. The cutting edge E may be located at the entire line of the intersection of the upper surface 12 and the lateral surface 16, or may be located at one part of the line of intersection of the upper surface 12 and the lateral surface 16.

As in the example illustrated in FIGS. 1 and 2, the upper surface 12 may include an outer edge 12p that is a contour of the upper surface 12. The outer edge 12p of the upper surface 12 may include first corners 20 as corner portions, and second corners 22 as other corner portions. The first corners 20 and the second corners 22 may be alternately located at the outer edge 12p of the upper surface 12. Each of the first corners 20 and the second corners 22 may have a protrusively curved shape protruding in an outward direction in the top view. In the top view is synonymous with a front view of the upper surface 12. The outward direction is a direction away from the insert central axis CS.

As in the example illustrated in FIGS. 1 and 2, the outer edge 12p of the upper surface 12 may include two side portions 24 extending from each of the first corners 20. Each of the side portions 24 may be connected to corresponding ones of the second corners 22. Each of the side portions 24 may have a linear shape in the top view. The linear shape in the top view is not limited to a strictly linear shape in the top view and includes a slightly curved shape.

As in the example illustrated in FIGS. 1 to 3, the upper surface 12 may include a land surface 26 located along the outer edge 12p. Note that the above-described “located along” indicates a state in which two target regions extend in the same direction. Thus, the two target regions may be separated from each other or may be in contact with each other.

For example, the land surface 26 being located along the outer edge 12p indicates a state in which the land surface 26 extends in accordance with the shape of the outer edge 12p. At this time, the land surface 26 may be connected to the outer edge 12p, or the land surface 26 may be slightly separated from the outer edge 12p.

Since the cutting edge E is located at the outer edge 12p, the land surface 26 may be located along the cutting edge E. The land surface 26 may function to enhance the cutting edge strength of the cutting edge E. One part of the land surface 26 may function as a rake surface. The land surface 26 may be connected to the cutting edge E.

As in the example illustrated in FIGS. 1 to 5, the upper surface 12 may include a main rake surface 28 located along the land surface 26, on the inner side of the land surface 26. The main rake surface 28 may mainly exhibit the function of a rake surface. The main rake surface 28 may be connected to the land surface 26. The main rake surface 28 may have a linear shape inclined with respect to a reference plane BF, so as to approach the reference plane BF with increasing distance from the land surface 26 in a cross section orthogonal to the outer edge 12p of the upper surface 12. The reference plane BF is a virtual flat surface located between the upper surface 12 and the lower surface 14 and orthogonal to the insert central axis CS. In IVB in FIG. 4, VB in FIG. 5, IVB in FIG. 6, VIIB in FIG. 7 and VIIIB in FIG. 8, the main rake surface 28 is illustrated using a bold line and has a linear shape in each cross-sectional view.

As in the example illustrated in FIGS. 1 to 3, the upper surface 12 may include a connecting surface 30 located along the main rake surface 28, on the inner side of the main rake surface 28. The connecting surface 30 may function as a rake surface. The connecting surface 30 may be connected to the main rake surface 28. The connecting surface 30 may have a recessed shape toward the reference plane BF in a cross section orthogonal to the outer edge 12p of the upper surface 12.

As in the example illustrated in FIGS. 1 to 3, the upper surface 12 may include a rising surface 32 located along the connecting surface 30, on the inner side of the connecting surface 30. The rising surface 32 may have a function of curling chips to enhance chip dischargeability. The rising surface 32 may be connected to the connecting surface 30. The rising surface 32 may be inclined with respect to the reference plane BF so as to be farther away from the reference plane BF with increasing distance from the connecting surface 30 in a cross section orthogonal to the outer edge 12p of the upper surface 12.

As in the example illustrated in FIGS. 1 and 2, the upper surface 12 may include an upper end surface (boss surface) 34 surrounding the one opening portion of the attachment hole 18. The upper end surface 34 may be orthogonal to the insert central axis CS. The upper end surface 34 may be connected to the rising surface 32 on the inner side of the rising surface 32.

As in the example illustrated in FIG. 2, each of the land surface 26 and the upper end surface 34 may have a symmetrical shape with respect to an insert central line CL. Each of the main rake surface 28, the connecting surface 30, and the rising surface 32 may be arranged symmetrically with respect to the insert central line CL. The insert central line CL refers to a virtual line passing through the vertices of the two first corners 20 and the insert axial center CS in the top view.

As in the example illustrated in FIGS. 1 and 2, the cutting edge E may include first cutting edges Ea located at the first corners 20 and second cutting edges Eb located at the side portions 24. The first cutting edge Ea may be located over the entirety of the first corner 20 or may be located at one part of the first corner 20. The second cutting edge Eb may be located over the entirety of the side portion 24 or may be located at one part of the side portion 24.

As in the example illustrated in FIG. 3, VIA in FIG. 4, VA in FIG. 5, VIA in FIG. 6, VIIA in FIG. 7, and VIIIA in FIG. 8, the land surface 26 may include a first land surface 36 located along the first corner 20 and a second land surface 38 located along the side portion 24. The land surface 26 may include a third land surface 40 located along the side portion 24, between the first land surface 36 and the second land surface 38. VA and VB in FIG. 5 illustrate a boundary portion between the first land surface 36 and the third land surface 40.

As in the example illustrated in FIG. 3, IVA in FIG. 4, IVB in FIG. 4, VA in FIG. 5, and VB in FIG. 5, the first land surface 36 may include a first linear portion 36s having a linear shape in a cross section orthogonal to the first corner 20 (a cross section orthogonal to the outer edge 12p of the upper surface 12). The first linear portion 36s of the first land surface 36 may be inclined with respect to the reference plane BF so as to approach the reference plane BF with increasing distance from the first corner 20 in a cross section orthogonal to the first corner 20. The first land surface 36 may include a first arc portion 36c having an arc shape in a cross section orthogonal to the first corner 20. The first arc portion 36c of the first land surface 36 may be connected to the lateral surface 16. In IVB in FIG. 4 and VB in FIG. 5, the first linear portion 36s of the first land surface 36 is illustrated in an emphasized manner using a bold line.

In a cross section orthogonal to the first corner 20, an inclination angle θ1 of the first linear portion 36s of the first land surface 36 with respect to a virtual flat surface VF orthogonal to the insert central axis CS may be smaller than an inclination angle α1 of the main rake surface 28. A width T1 of the first land surface 36 in a direction orthogonal to the first corner 20 may increase with decreasing distance from the side portion 24 in the top view. A length M1 of the first linear portion 36s of the first land surface 36 in a cross section orthogonal to the first corner 20 may increase with decreasing distance from the side portion 24. Since the reference plane BF is orthogonal to the insert central axis CS, the virtual flat surface VF is parallel to the reference plane BF. Thus, for example, the inclination angle θ1 may be replaced with an inclination angle of the first linear portion 36s with respect to the reference plane BF.

As in the example illustrated in FIG. 3, VIIA in FIG. 7, VIIB in FIG. 7, VIIIA in FIG. 8, and VIIIB in FIG. 8, the second land surface 38 may have a protrusively curved shape as a whole protruding in an upward direction in a cross section orthogonal to the side portion 24 (a cross section orthogonal to the outer edge 12p of the upper surface 12). The second land surface 38 may include a second arc portion 38c having an arc shape in a cross section orthogonal to the side portion 24. The second arc portion 38c of the second land surface 38 may be connected to the lateral surface 16.

A width T2 of the second land surface 38 in a direction orthogonal to the side portion 24 may increase with increasing distance from the first corner 20 in the top view. The second arc portion 38c of the second land surface 38 may be connected to the lateral surface 16. A radius of curvature R1 of the first arc portion 36c of the first land surface 36 and a radius of curvature R2 of the second arc portion 38c of the second land surface 38 may be the same. The two radii of curvature R1 and R2 being the same means that the difference between the two radii of curvature R1 and R2 is within a range of ±5% of the mean value of the two radii of curvature R1 and R2 in consideration of manufacturing errors and the like.

As in the example illustrated in FIG. 3, VA in FIG. 5, VB in FIG. 5, VIA in FIG. 6, and VIB in FIG. 6, the third land surface 40 may include a second linear portion 40s having a linear shape in a cross section orthogonal to the side portion 24 (a cross section orthogonal to the outer edge 12p of the upper surface 12). The second linear portion 40s of the third land surface 40 may be inclined with respect to the reference plane BF so as to approach the reference plane BF with increasing distance from the side portion 24 in a cross section orthogonal to the side portion 24. The third land surface 40 may include a third arc portion 40c having an arc shape in a cross section orthogonal to the side portion 24. The third arc portion 40c of the third land surface 40 may be connected to the lateral surface 16. In VB in FIG. 5 and VIB in FIG. 6, the second linear portion 40s of the third land surface 40 is illustrated using a bold line.

In a cross section orthogonal to the side portion 24, an inclination angle θ2 of the second linear portion 40s of the third land surface 40 with respect to the virtual flat surface VF orthogonal to the insert central axis CS may be smaller than an inclination angle α2 of the main rake surface 28. A width T3 of the third land surface 40 in the direction orthogonal to the side portion 24 may be constant in the top view. A length M2 of the second linear portion 40s of the third land surface 40 in a cross section orthogonal to the side portion 24 may be constant. Note that, as described above, the virtual flat surface VF is parallel to the reference plane BF. Thus, for example, the inclination angle θ2 may be replaced with an inclination angle of the second linear portion 40s with respect to the reference plane BF.

The radius of curvature R1 of the first arc portion 36c of the first land surface 36, the radius of curvature R2 of the second arc portion 38c of the second land surface 38, and a radius of curvature R3 of the third arc portion 40c of the third land surface 40 may be the same. The three radii of curvature R1, R2, and R3 being the same means that the maximum difference between the three radii of curvature R1, R2, and R3 is within a range of ±5% of the mean value of the three radii of curvature R1, R2, and R3 in consideration of manufacturing errors and the like.

As in the example illustrated in FIGS. 1 and 2, examples of the material of the cutting insert 10 include cemented carbide alloy and cermet. Examples of the composition of the cemented carbide alloy include WC-Co produced by adding cobalt (Co) powder to tungsten carbide (WC) and sintering the mixture, WC—TiC—Co formed by adding titanium carbide (TiC) to WC—Co, and WC—TiC—TaC—Co formed by adding tantalum carbide (TaC) to WC—TiC—Co. The cermet is a sintered composite material obtained by combining a metal with a ceramic component, and specific examples thereof include titanium compounds in which a titanium compound such as titanium carbide (TiC) or titanium nitride (TiN) is the main component.

The surface of the cutting insert 10 may be coated with a coating film using a chemical vapor deposition (CVD) method or a physical vapor deposition (PVD) method. The composition of the coating film includes, for example, titanium carbide (TiC), titanium nitride (TiN), titanium carbonitride (TiCN), and alumina (Al₂O₃).

According to the example of the embodiment of the present disclosure, the first land surface 36 is located along the first corner 20, that is, located near a machined surface of the workpiece W. The first land surface 36 includes the first linear portion 36s having a linear shape in a cross section orthogonal to the first corner 20. According to the example of the embodiment of the present disclosure, the first cutting edge Ea of the cutting edge E can be sharpened to enhance the sharpness of the cutting edge E and improve the surface accuracy of the workpiece W.

According to the example of the embodiment of the present disclosure, the second land surface 38 is located along the side portion 24 that is separated from the machined surface of the workpiece W and plays a major role in machining the workpiece W. The entirety of the second land surface 38 has the protrusively curved shape in the cross section orthogonal to the side portion 24. According to the example of the embodiment of the present disclosure, edge chipping or the like is less likely to occur in the cutting edge E, and the durability of the cutting insert 10 can be improved.

In other words, according to the example of the embodiment of the present disclosure, both the improvement of the surface accuracy of the workpiece W and the improvement of the durability of the cutting insert 10 can be achieved.

In a case that the first linear portion 36s of the first land surface 36 approaches the reference plane BF with increasing distance from the first corner 20 in a cross section orthogonal to the first corner 20, the first cutting edge Ea can be sharpened to further enhance the sharpness of the cutting edge E, thereby further improving the surface accuracy of the workpiece W.

In a cross section orthogonal to the first corner 20, in a case that the inclination angle θ1 of the first linear portion 36s of the first land surface 36 is smaller than the inclination angle al of the main rake surface 28, space can be secured for the chips to flow and the chip flow can be controlled, while sufficiently enhancing the cutting edge strength of the cutting edge E, particularly the cutting edge strength of the first cutting edge Ea.

In a case that the radius of curvature R1 of the first arc portion 36c of the first land surface 36 and the radius of curvature R2 of the second arc portion 38c of the second land surface 38 are the same, variation in the sharpness of the cutting edge E is reduced, and the surface accuracy of the workpiece W is further improved. Particularly, in a case that the radius of curvature R1 of the first arc portion 36c of the first land surface 36, the radius of curvature R2 of the second arc portion 38c of the second land surface 38, and the radius of curvature R3 of the third arc portion 40c of the third land surface 40 are the same, the variation in the sharpness of the cutting edge E can be sufficiently reduced, and the surface accuracy of the workpiece W can be further improved.

In a case that the width T1 of the first land surface 36 in the direction orthogonal to the first corner 20 increases with decreasing distance from the side portion 24, the portion of the first cutting edge Ea farther from the second cutting edge Eb can be further sharpened to further enhance the sharpness of the cutting edge E, and thus the surface accuracy of the workpiece W can be further improved. In a case that the length M1 of the first linear portion 36s of the first land surface 36 in a cross section orthogonal to the first corner 20 increases with decreasing distance from the side portion 24, the portion of the first cutting edge Ea farther from the second cutting edge Eb can be further sharpened, and thus the surface accuracy of the workpiece W can be further improved.

In a case that the width T2 of the second land surface 38 in the direction orthogonal to the side portion 24 increases with increasing distance from the first corner 20, the farther a region of the second land surface 38 is from the first land surface 36, the more the cutting edge strength of the cutting edge E can be enhanced. Accordingly, even in a case of machining with a large depth of cut (machining with a large cutting amount), edge chipping or the like is less likely to occur in the cutting edge E, and the durability of the cutting insert 10 can be further improved.

In a case that the third land surface 40 includes the second linear portion 40s having a linear shape in a cross section orthogonal to the side portion 24, a marked decrease in the sharpness of the cutting edge E can be avoided even under a first machining condition using the first cutting edge Ea and the second cutting edge Eb, as compared with in a case that the entire portion of the land surface 26 along the side portion 24 is the second land surface 38. Accordingly, the surface accuracy of the workpiece W can be improved even under the first machining condition.

In a case that the width T3 of the third land surface 40 in the direction orthogonal to the side portion 24 is constant, chip flow directions are aligned at the third land surface 40 under a second machining condition in which the first land surface 36 and the third land surface 40 contribute to the chip flow control and the second land surface 38 does not contribute to the chip flow control. Accordingly, under the second machining condition, the chip flow at the third land surface 40 becomes dominant, the chips are less likely to be clogged at the land surface 26, and the chip dischargeability can be enhanced.

### Cutting Tool

A cutting tool 42 according to the embodiment of the present disclosure will be described with reference to FIG. 9. FIG. 9 is a schematic perspective view of the cutting tool 42 according to the embodiment of the present disclosure.

As in the example illustrated in FIG. 9, the cutting tool 42 according to the embodiment of the present disclosure may be a tool used in turning processes, among machining processes of the workpiece W. Examples of turning processes include external turning, groove-forming, and cutting-off processing. The cutting tool 42 according to the embodiment of the present disclosure may include a holder 44 having a rod shape. The holder 44 may extend from a first end (front end) 44a thereof toward a second end (rear end) 44b thereof. The holder 44 is made of, for example, a metal material such as steel. The holder 44 may include a pocket 46 located at a side of the first end 44a. The holder 44 may include a screw hole that is open at the pocket 46.

The cutting tool 42 may include the cutting insert 10 located at the pocket 46 of the holder 44. The cutting insert 10 is attached to the pocket 46 of the holder 44 by screwing and tightening a clamp screw 48 inserted into the attachment hole 18 of the cutting insert 10, into a screw hole of the holder 44.

In the present disclosure, the cutting tool 42 used in a turning process, among the machining processes, is exemplified. However, a cutting tool used for milling, among the machining processes, may include the cutting insert 10 as a component.

### Method for Manufacturing Machined Product

The method for manufacturing the machined product according to the embodiment of the present disclosure will be described with reference to FIGS. 10 to 12. FIGS. 10 to 12 are schematic views illustrating the method for manufacturing the machined product according to the embodiment of the present disclosure.

As illustrated in FIGS. 10 to 12, the method for manufacturing the machined product according to the embodiment of the present disclosure is a method for manufacturing a machined product M, which is the workpiece W after the machining, and includes a first step, a second step, and a third step. The first step is a step of rotating the workpiece W about an axis S thereof. The second step is a step of bringing the cutting insert 10 of the cutting tool 42 into contact with the rotating workpiece W to cut the workpiece W. The third step is a step of separating the cutting tool 42 from the cut workpiece W. Examples of the material of the workpiece W include stainless steel, carbon steel, alloy steel, cast iron, and a non-ferrous metal. The specific content of the method for manufacturing the machined product according to the embodiment is as follows.

The cutting tool 42 is attached to a cutting tool rest of a lathe, and the workpiece W is mounted on a chuck of the lathe. As in the example illustrated in FIG. 10, the chuck is rotated to rotate the workpiece W around the axis S thereof (first step). As in the example illustrated in FIG. 11, the cutting tool 42 is moved in a direction of an arrow D1 and made to approach the workpiece W, and the cutting insert 10 of the cutting tool 42 is brought into contact with the rotating workpiece W to cut the workpiece W (second step). Accordingly, a machined surface Wf can be formed on the workpiece W.

Subsequently, as in the example illustrated in FIG. 12, the cutting tool 42 is separated from the workpiece W by moving the cutting tool 42 in a direction of an arrow D2 (third step). This completes the machining of the workpiece W and enables the machined product M, which is the workpiece W after the machining, to be manufactured. Since the cutting insert 10 of the cutting tool 42 has excellent cutting capabilities for the above-described reasons, the machined product M having excellent machining accuracy can be manufactured.

In a case that the machining is continued, the cutting insert 10 of the cutting tool 42 may be repeatedly brought into contact with a different portion of the workpiece W while the workpiece W is being rotated. In the embodiment of the present disclosure, the cutting tool 42 is brought closer to the workpiece W. However, as long as the cutting tool 42 and the workpiece W are brought relatively closer to each other, the workpiece W may be brought closer to the cutting tool 42. In this respect, the same procedure is performed if separating the cutting tool 42 from the workpiece W.

In one embodiment, (1) a cutting unit includes an upper surface, a lower surface located on an opposite side to the upper surface, a lateral surface located between the upper surface and the lower surface, and a cutting edge located at an intersection of the upper surface and the lateral surface. In a case that a virtual axis that passes through the center of the upper surface and the center of the lower surface is set as an insert central axis, and a virtual flat surface located between the upper surface and the lower surface and orthogonal to the insert central axis is set as a reference plane, the upper surface includes an outer edge including a corner portion having a protrusively curved shape and a side portion having a linear shape and extending from the corner portion, a land surface located along the outer edge, and a main rake surface located along the land surface and having a linear shape, in a cross section orthogonal to the outer edge, that approaches the reference plane with increasing distance from the land surface. The land surface includes a first land surface located along the corner portion and a second land surface located along the side portion. The first land surface includes a first linear portion having a linear shape in a cross section orthogonal to the corner portion. The second land surface has a protrusively curved shape as a whole in a cross section orthogonal to the side portion.
(2) In the cutting insert according to (1) described above, a width of the first linear portion in a direction orthogonal to the corner portion may approach the reference plane with increasing distance from the corner portion in a cross section orthogonal to the corner portion.
(3) In the cutting insert according to (2) described above, in the cross section orthogonal to the corner portion, an inclination angle of the first linear portion with respect to a virtual flat surface orthogonal to the insert central axis may be smaller than an inclination angle of the main rake surface.
(4) In the cutting insert according to any one of (1) to (3) described above, the first land surface may further include a first arc portion connected to the lateral surface and having an arc shape in the cross section orthogonal to the corner portion. The second land surface may include a second arc portion connected to the lateral surface and having an arc shape in the cross section orthogonal to the side portion. A radius of curvature of the first arc portion and a radius of curvature of the second arc portion may be the same.
(5) In the cutting insert according to any one of (1) to (4) described above, a width of the first land surface in a direction orthogonal to the corner portion may increase with decreasing distance to the side portion.
(6) In the cutting insert according to (5) described above, a length of the first linear portion in the cross section orthogonal to the corner portion may increase with decreasing distance to the side portion.
(7) In the cutting insert according to any one of (1) to (6) described above, a width of the second land surface in a direction orthogonal to the side portion may increase with increasing distance from the corner portion.
(8) In the cutting insert according to any one of (1) to (7) described above, the land surface may further include a third land surface located along the side portion between the first land surface and the second land surface. The third land surface may include a second linear portion having a linear shape in the cross section orthogonal to the side portion.
(9) In the cutting insert according to (8) described above, a width of the third land surface in the direction orthogonal to the side portion may be constant.
(10) A cutting tool includes a holder having a rod shape extending from a first end to a second end and including a pocket located on a side of the first end, and the cutting insert according to any one of (1) to (9), the cutting insert being located in the pocket.
(11) A method for manufacturing includes rotating a workpiece, bringing the cutting tool according to (10) into contact with the rotating workpiece, and separating the cutting tool from the workpiece.

In the present disclosure, the invention has been described above based on the drawings and embodiments. However, the invention according to the present disclosure is not limited to the above-described embodiment. That is, the invention according to the present disclosure can be modified in various ways within the scope illustrated in the present disclosure, and embodiments obtained by appropriately combining the technical means disclosed in different embodiments are also included within the technical scope of the invention according to the present disclosure. In other words, those skilled in the art can easily make various variations or modifications based on the present disclosure. Note that these variations or modifications are included within the scope of the present disclosure.

### Reference Signs

10 Cutting insert
12 Upper surface
12p Outer edge
14 Lower surface
16 Lateral surface
18 Attachment hole
20 First corner (corner portion)
22 Second corner (another corner portion)
24 Side portion
26 Land surface
28 Main rake surface
30 Connecting surface
32 Rising surface
34 Upper end surface
36 First land surface
36s First linear portion
36c First arc portion
38 Second land surface
38c Second arc portion
40 Third land surface
40s Second linear portion
40c Third arc portion
42 Cutting Tool
44 Holder
46 Pocket
48 Clamp screw
E Cutting edge
Ea First cutting edge
Eb Second cutting edge

1. A cutting insert comprising:
an upper surface;
a lower surface located on an opposite side of the upper surface;
a lateral surface located between the upper surface and the lower surface; and
a cutting edge located at an intersection of the upper surface and the lateral surface, wherein
in a case that a virtual axis that passes through a center of the upper surface and a center of the lower surface is set as an insert central axis, and a virtual flat surface that is located between the upper surface and the lower surface and orthogonal to the insert central axis is set as a reference plane,
the upper surface comprises
an outer edge comprising a corner portion having a protrusively curved shape and a side portion having a linear shape and extending from the corner portion,
a land surface located along the outer edge, and
a main rake surface located along the land surface and having a linear shape, in a first cross section orthogonal to the outer edge, that is closer to the reference plane as farther away from the land surface,
the land surface comprises
a first land surface located along the corner portion, and
a second land surface located along the side portion,
the first land surface comprises a first linear portion having a linear shape in a second cross section orthogonal to the corner portion, and
the second land surface has a protrusively curved shape as a whole in a third cross section orthogonal to the side portion.

2. The cutting insert according to claim 1, wherein,
in the second cross section the first linear portion is closer to the reference plane as farther away from the corner portion.

3. The cutting insert according to claim 2, wherein
in the second cross section, an inclination angle of the first linear portion with respect to a virtual flat surface orthogonal to the insert central axis is smaller than an inclination angle of the main rake surface.

4. The cutting insert according to claim 1, any wherein
the first land surface further comprises a first arc portion connected to the lateral surface and having an arc shape in the second cross section,
the second land surface comprises a second arc portion connected to the lateral surface and having an arc shape in the third cross section, and
a radius of curvature of the first arc portion is same to a radius of curvature of the second arc portion.

5. The cutting insert according to claim 1, wherein
a width of the first land surface in a first direction orthogonal to the corner portion increases with decreasing distance to the side portion.

6. The cutting insert according to claim 5, wherein
a length of the first linear portion in the second cross section increases with decreasing distance to the side portion.

7. The cutting insert according to claim 1, wherein
a width of the second land surface in a second direction orthogonal to the side portion increases with increasing distance from the corner portion.

8. The cutting insert according to claim 1, wherein
the land surface further comprises a third land surface located along the side portion, between the first land surface and the second land surface, and
the third land surface comprises a second linear portion having a linear shape in the third cross section.

9. The cutting insert according to claim 8, wherein
a width of the third land surface in the second direction is constant.

10. A cutting tool comprising:
a holder having a rod shape extending from a first end to a second end, and comprising a pocket located on a side of the first end; and
the cutting insert according to claim 1, the cutting insert being located in the pocket.

11. A method for manufacturing a machined product, the method comprising:
rotating a workpiece;
bringing the cutting tool according to claim 10 into contact with the rotating workpiece; and
separating the cutting tool from the workpiece.
